(19) United States
(12) Patent Application Publication
(10) Pub. No.: US 2003/0163762 A1
(43) Pub. Date: Aug. 28, 2003

(54) Fault tolerant transmission device and method for information processing systems

(76) Inventor: Chun Liang Lee, Taipei (TW)

Correspondence Address: JACOBSON HOLMAN PLLC, 400 SEVENTH STREET N.W., SUITE 600, WASHINGTON, DC, 20004, US

(21) Appl. No.: 10/080,554

(22) Filed: Feb. 25, 2002

(51) Int. Cl. G06F 11/00; H04L 1/22

(52) U.S. Cl. 714/11; 714/4

(57) ABSTRACT

A fault tolerant transmission device and method for information processing systems. The fault tolerant transmission device utilizes a connecting system to connect to a SCSI bus. Along with the use of the disclosed fault tolerant transmission method of the server, the device manages information transmission of independent systems. When the independent system has errors and is unable to transmit information, the connecting system of the fault tolerant transmission device assigns the information transmission job to a normal independent system and notifies the user, so that the information processing system can still function normally when some independent systems have errors.

### BACKGROUND OF THE INVENTION

1. Field of Invention

The invention relates to a fault tolerant transmission device and, in particular, to a fault tolerant transmission device and its method for information processing systems.

2. Related Art

Information processing systems are served to provide specific services for different terminals, such as databases, file storage, printers, E-mail and web pages. To achieve the goal of servicing multiple terminals, it is necessary to be able to simultaneously process requests and messages transmitted from multiple terminals and to make appropriate responses. Therefore, to be able to receive information sent from the terminals the hardware has to be equipped with several sets of I/O (input/output) ports, and the software has to be able to manage and organize the transmitted information.

Since the information processing system has to service several terminals at a time, many independent systems and SCSI's (small computer system interface) are often provided in the server. The SCSI is an interface that connects various computer peripheral devices to an expanded bus. With the use of the SCSI, the CPU has a lower load, a more stable transmission, and a faster speed than other interfaces. Therefore, normal information processing systems or workstations often use the SCSI as the interface for hard disk drives or other storage devices.

However, when some of the independent systems have errors and cannot function correctly, the corresponding SCSI buses often cannot continue transmitting information, interrupting services for some terminals. This causes inconvenience for users. Consequently, how to increase the fault tolerance ability of the information processing system to avoid the inconvenience due to errors in independent systems is an important issue in the field.

### SUMMARY OF THE INVENTION

Therefore, the invention provides a fault tolerant transmission device and method for information processing systems. An important objective of the invention is to use normally functioning independent systems to continue finishing information transmission when some independent systems have errors and are unable to transmit data.

According to the invention, the fault tolerant transmission device utilizes a connecting system to connect to a SCSI bus. Along with the use of the disclosed fault tolerant transmission method of the server, the device manages information transmission of independent systems. When the independent system has errors and is unable to transmit information, the connecting system of the fault tolerant transmission device assigns the information transmission job to a normal independent system and notifies the user, so that the information processing system can still function normally when some independent systems have errors.

### BRIEF DESCRIPTION OF THE DRAWINGS

The invention will become more fully understood from the detailed description given hereinbelow illustration only, and thus are not limitative of the present invention, and wherein:

FIG. 1 is a system block diagram of the disclosed fault tolerant transmission device for information processing systems;

FIG. 2 is a block diagram of a first independent system in FIG. 1;

FIG. 3 is a block diagram of a second independent system in FIG. 1; and

FIG. 4 is a flowchart of the steps in the disclosed fault tolerant transmission method.

### DETAILED DESCRIPTION OF THE INVENTION

This specification discloses a fault tolerant transmission device and the corresponding method for information processing systems. The fault tolerant transmission device utilizes a connecting system to connect to a SCSI (small computer system interface) bus and, along with the use of the disclosed fault tolerant transmission method of the server, manages information transmission of independent systems.

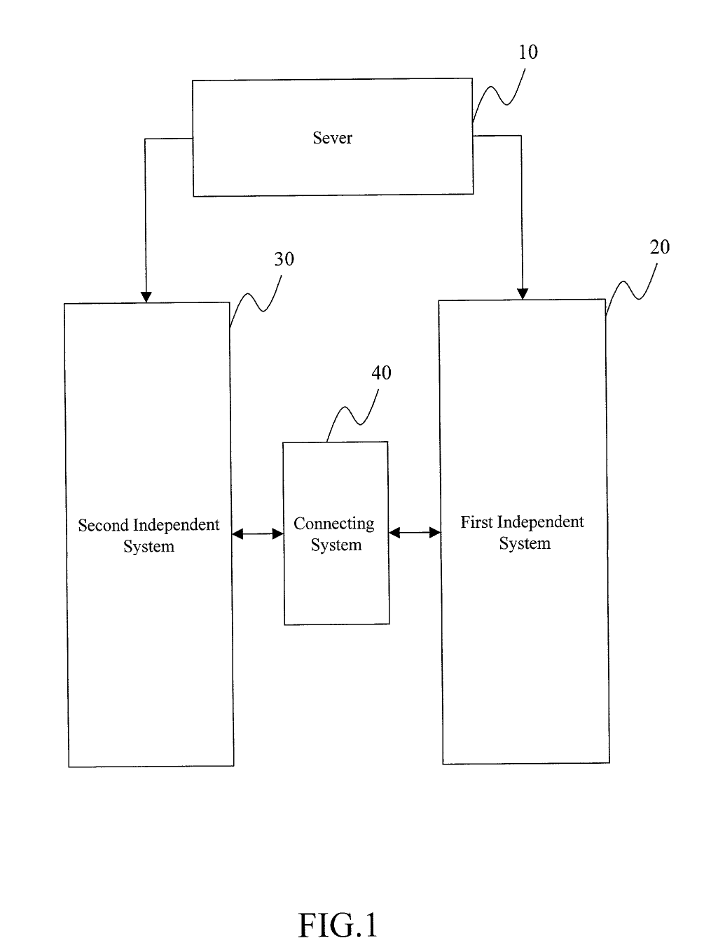

With reference to FIG. 1, the information processing system is installed with a first independent system 20 and a second independent system 30. The fault tolerant transmission device contains a server 10 and a connecting system 40. The server 10 has a GPIO (general purpose input/output) interface connecting with the first independent system 20 and the second independent system 30. When any of the independent systems 20, 30 has errors and cannot transmit data, an enable signal is sent to the first independent system 20 or the second independent system 30. The connecting system 40 can be a SCSI bus bridge or a SCSI bus expander. The connecting system also connects to the first independent system 20 and the second independent system 30. After the connecting system 40 receives the enable signal, the data that the independent system with errors cannot transmit are transmitted through the other independent system through the connecting system 40.

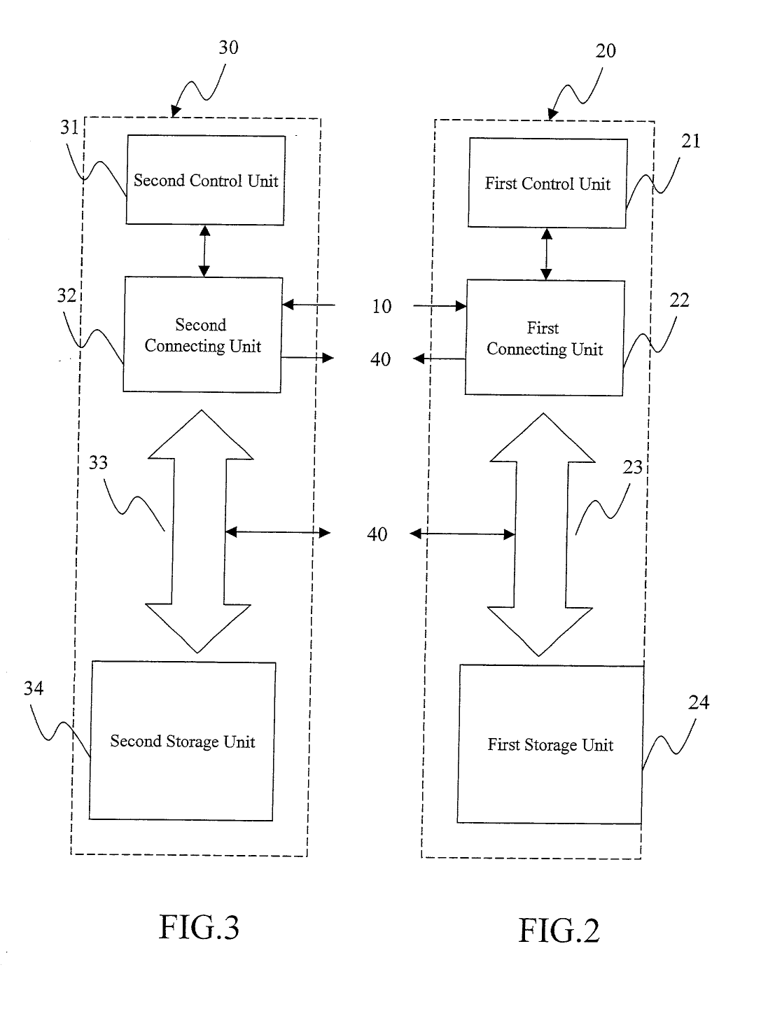

With reference to FIG. 2, the first independent system 20 of the invention contains at least: a first control unit 21, a first connecting unit 22, a first transmission unit 23, and a first storage unit 24. The first control unit 21 controls the data transmission of the first independent system 20. The first connecting unit 22 is connected to the first control unit 21 for receiving commands therefrom. The first connecting unit 22 is a SCSI connector and connects to the server 10 for simultaneously receiving the enable signal and transmitting it to the connecting system 40. The first transmission unit 23 of the invention is a SCSI bus and connected to the first connecting unit 22 for transmitting data of the first independent system 20. The first transmission unit 23 is also connected to the connecting system 40. When the second independent system 30 has errors and cannot function correctly, the first transmission unit 23 has to transmit data for both the first independent system 20 and the second independent system 30. The first storage unit 24 contains at least one hard disk drive. The first storage unit 24 is connected to the first transmission unit 23 for storing data of the first independent system 20.

With reference to FIG. 2, the second independent system 30 of the invention contains at least: a second control unit 31, a second connecting unit 32, a second transmission unit 33, and a second storage unit 34. The second control unit 31 controls the data transmission of the second independent system 30. The second connecting unit 32 is connected to the second control unit 31 for receiving commands therefrom. The second connecting unit 32 is also a SCSI connector and connects to the server 10 for simultaneously receiving the enable signal and transmitting it to the connecting system 40. The second transmission unit 33 of the invention is a SCSI bus and connected to the second connecting unit 32 for transmitting data of the second independent system 30. The second transmission unit 33 is also connected to the connecting system 40. When the first independent system 20 has errors and cannot function correctly, the second transmission unit 33 has to transmit data for both the first independent system 20 and the second independent system 30. The second storage unit 34 contains at least one hard disk drive. The second storage unit 34 is connected to the second transmission unit 33 for storing data of the second independent system 30.

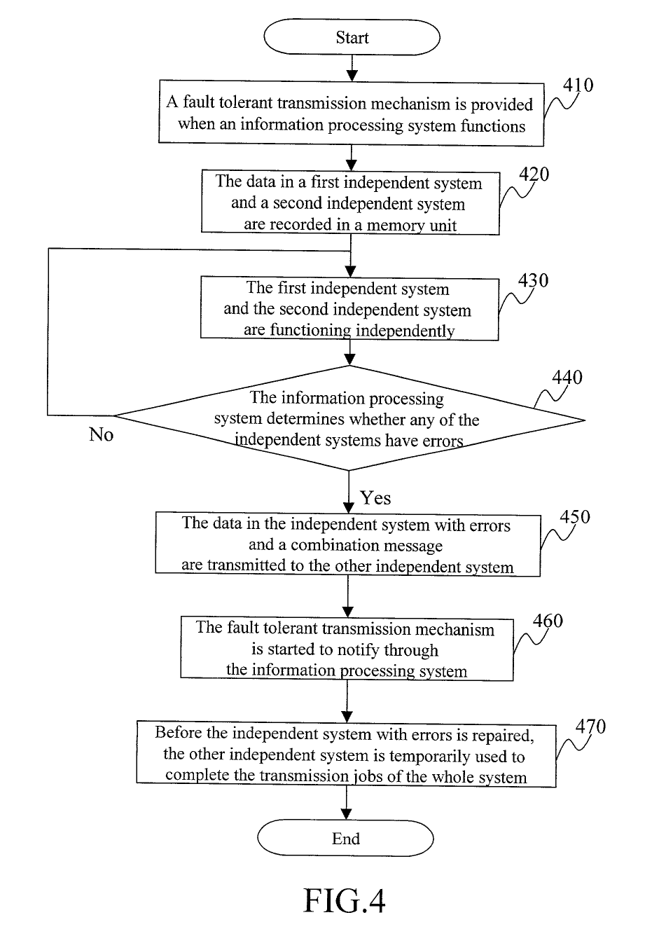

As shown in FIG. 4, a fault tolerant transmission mechanism is provided when an information processing system functions (step 410). The data in a first independent system and a second independent system are recorded in a memory unit (step 420). The memory unit is can be MOS (metal oxide semiconductor) or NVRAM (non-volatile random access memory). The first independent system and the second independent system are functioning independently (step 430). The information processing system determines whether any of the independent systems have errors (step 440). If there is no error occurring, then step 430 follows. If any error occurs to any of the independent systems, the data in the independent system with errors and a combination message are transmitted to the other independent system (step 450). The fault tolerant transmission mechanism is started to notify through the information processing system the user that an independent system has errors (step 460). Before the independent system with errors is repaired, the other independent system is temporarily used to complete the transmission jobs of the whole system.

As described before, the invention provides a fault tolerant transmission device and method for information processing systems. One advantage is that when some of the independent systems have errors and cannot function correctly, other normal independent systems can be used to share the work of the independent systems with errors. In contrast, conventional information processing systems must be turned off and get repaired in order to maintain the normal functions of the whole information processing system when errors occur. The invention allows the user to decide when to repair the independent systems. Before the independent systems with errors are repaired, the functioning of the whole information processing system is not affected. Therefore, the operation of the server becomes more efficient.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A fault tolerant transmission device for an information processing system with a first independent system and a second independent system, which comprises:
a server, which is connected to the first independent system and the second independent system for sending an enable signal when any of the independent systems has errors and cannot transmit data; and
a connecting system, which is connected to the first independent system and the second independent system for transmitting data that are unable to be transmitted by the independent system with errors through the connecting system and the other independent system after the enable signal is received.

2. The device of claim 1, wherein the first independent system further comprises:
a first control unit, which controls the data transmission of the first independent system;
a first connecting unit, which is connected to the first control unit for receiving commands from the first control unit and is connected to the server for receiving the enable signal and transmitting the enable signal to the connecting system;
a first transmission unit, which is connected to the first connecting unit for transmitting data of the first independent system, is connected to the connecting system, and simultaneously transmits data of the first independent system and the second independent system when the second independent system has errors; and
a first storage unit, which is connected to the first transmission unit for storing data of the first independent system.

3. The device of claim 2, wherein the first transmission unit is a SCSI (small computer system interface) bus.

4. The device of claim 2, wherein the first connecting unit is a SCSI (small computer system interface) connector.

5. The device of claim 2, wherein the first storage unit further contains at least one hard disk drive.

6. The device of claim 1, wherein the second independent system further comprises:
a second control unit, which controls the data transmission of the second independent system;
a second connecting unit, which is connected to the second control unit for receiving commands from the second control unit and is connected to the server for receiving the enable signal and transmitting the enable signal to the connecting system;
a second transmission unit, which is connected to the second connecting unit for transmitting data of the second independent system, is connected to the connecting system, and simultaneously transmits data of the second independent system and the second independent system when the first independent system has errors; and
a second storage unit, which is connected to the second transmission unit for storing data of the second independent system.

7. The device of claim 6, wherein the second transmission unit is a SCSI (small computer system interface) bus.

8. The device of claim 6, wherein the second connecting unit is a SCSI (small computer system interface) connector.

9. The device of claim 6, wherein the second storage unit further contains at least one hard disk drive.

10. The device of claim 1, wherein the connecting system is a SCSI bus bridge.

11. The device of claim 1, wherein the connecting system is a SCSI bus expander.

12. The device of claim 1, wherein the server is further installed with a GPIO (general purpose input/output) interface for connecting the first connecting unit and the second connecting unit.

13. A fault tolerant transmission method for an information processing system with a first independent system and a second independent system, which comprises the steps of:
providing a fault tolerant mechanism when the information processing system is functioning;
recording data of the first independent system and the second independent system in a memory unit;
independently transmitting data in the first independent system and the second independent system;
the information processing system monitoring when any of the independent systems has errors and does not function correctly;
sending data of the independent system with errors along with a combination message to the other independent system;
starting the fault tolerant transmission mechanism and notifying a user through the information processing system; and
the normally functioning independent system temporarily completing transmission jobs before the independent system with errors is repaired.

14. The method of claim 13, wherein the memory unit is an MOS (metal oxide semiconductor).

15. The method of claim 13, wherein the memory unit is an NVRAM (non-volatile random access memory).
